(19) United States
(12) Patent Application Publication
(10) Pub. No.: US 2025/0346137 A1
(43) Pub. Date: Nov. 13, 2025

(54) CHARGING SYSTEM

(71) Applicants: Hyundai Motor Company, Seoul (KR); Kia Corporation, Seoul (KR)

(72) Inventors: Dong Hun Lee, Hwaseong-Si, Gyeonggido (KR); Yong Chul Shin, Hwaseong-Si (KR); Byung Ho Yoon, Hwaseong-Si (KR); Ki Hoon Nam, Hwaseong-Si (KR)

(21) Appl. No.: 18/917,610

(22) Filed: Oct. 16, 2024

(30) Foreign Application Priority Data
May 10, 2024 (KR) 10-2024-0062036

(51) Int. Cl. B60L 53/35; B60L 53/16; H01R 13/453; H02J 7/00

(52) U.S. Cl. CPC B60L 53/35; B60L 53/16; H02J 7/0042; H01R 13/453

(57) ABSTRACT

A system for charging an object is introduced. The system may comprise a charging socket provided in the object and configured to couple to a charger, a charging robot configured to move the charger, a charging socket cover provided on the object and configured to move, based on contact of the charging robot, from a closed position, where the charging socket cover closes the charging socket, to an open position, where the charging socket cover opens the charging socket, and a cover locker configured to secure the charging socket cover disposed at the closed position or the open position.

### CROSS-REFERENCE TO RELATED APPLICATION

This application claims priority to and the benefit of Korean Patent Application No. 10-2024-0062036 filed in the Korean Intellectual Property Office on May 10, 2024, the entire contents of which are incorporated herein by reference.

### TECHNICAL FIELD

The present disclosure relates to a charging system, and more particularly, to a charging system capable of simplifying and automating a charging process.

### BACKGROUND

The matters described in this Background section are only for enhancement of understanding of the background of the disclosure, and should not be taken as acknowledgement that they correspond to prior art already known to those skilled in the art.

Electric vehicles (EVs) (or hybrid vehicles) are being actively researched as the most promising alternative to cope with future vehicle pollution and energy issues.

The electric vehicle generates driving power by an electric motor (drive motor) that obtains a rotational force from electrical energy. Therefore, the electric vehicle is equipped with a battery capable of supplying electrical energy used to drive the electric vehicle, and the battery mounted in the vehicle needs to be often charged to drive the electric vehicle.

A charging socket (or an inlet) is provided in a vehicle body of the electric vehicle to charge the electric vehicle (battery), and a connector of an electric vehicle charging device is provided in a charging station and configured to be selectively coupled to the charging socket to transfer electrical energy to the electric vehicle.

In addition, the electric vehicle may be provided with a charging socket cover for preventing the charging socket (e.g., a quick charging socket) from being exposed to an environment such as rain or snow.

However, in the related art, a user needs to manually couple a charger, which is provided in the charging station, to the charging socket (connect a charging connector of the charger to the charging socket) to charge the battery, and the user needs to separate the charger from the charging socket after the charging process is completed, which may cause an inconvenience and discomfort to the user.

In order to solve the problem, a method of performing a process of coupling the charger to the charging socket in an unmanned manner by using a charging robot is being considered.

However, even if the process of coupling the charger to the charging socket is automated by using the charging robot, a process of opening or closing the charging socket cover needs to be manually operated by the user, which causes a problem in that the process of charging the electric vehicle cannot be completely automated and unmanned.

In addition, in order to automate the process of opening or closing the charging socket cover, a cover opening/closing robot needs to be additionally provided separately from the charging robot or a structure of the charging robot needs to be changed (designed and modified) to a structure capable of opening or closing the charging socket cover (a structure capable of gripping a handle of the charging socket cover and pulling the charging socket cover), which causes a problem in that costs are increased, and a spatial utilization and a degree of design freedom are degraded.

Accordingly, there is a need to develop a technology to simplify and automate the process of charging the electric vehicle and improve the user convenience.

### SUMMARY

According to the present disclosure, a system for charging an object, the system may comprise a charging socket provided in the object and configured to couple to a charger, a charging robot configured to move the charger, a charging socket cover provided on the object and configured to move, based on contact of the charging robot, from a closed position, where the charging socket cover closes the charging socket, to an open position, where the charging socket cover opens the charging socket, and a cover locker configured to secure the charging socket cover disposed at the closed position or the open position.

The system may comprise a cover lever provided on the charging socket cover so that the charging robot comes into contact with the cover lever, wherein the charging socket cover is configured to move, based on contact between the charging robot and the cover lever, from the closed position to the open position.

The system, wherein the contact between the charging robot and the cover lever is made by a rectilinear movement of the charging robot.

The system, wherein the charging socket cover is configured to be rotatable around a rotary shaft from the closed position to the open position.

The system, wherein the cover locker may comprise a cam member provided on the object and having a cam profile provided along a periphery of the cam member, and a cam plunger provided in the charging socket cover so as to come into elastic contact with the cam profile, wherein the cam plunger is configured to move, based on a rotation of the charging socket cover, along the cam profile.

The system, wherein the cam profile may comprise a first cam portion configured to be spaced apart from a rotation center of the charging socket cover at a first distance, a second cam portion continuously connected to a first end of the first cam portion and configured to be spaced apart from the rotation center of the charging socket cover at a second distance shorter than the first distance, and a third cam portion continuously connected to a second end of the first cam portion and configured to be spaced apart from the rotation center of the charging socket cover at a third distance shorter than the first distance, wherein the charging socket cover disposed at the closed position is secured based on the cam plunger being in contact with the second cam portion, and wherein the charging socket cover disposed at the open position is secured based on the cam plunger being in contact with the third cam portion.

The system, wherein the cam plunger may comprise a contact member provided in the charging socket cover and configured to be movable in a direction in which the contact member comes into contact with or moves away from the cam profile, and an elastic member configured to elastically support a movement of the contact member relative to the charging socket cover.

The system, wherein the cover locker may comprise a spring member configured to provide an elastic force to allow the charging socket cover to rotate from the open position to the closed position, a restriction portion provided in the object, and a ball plunger provided in the charging socket cover and configured to be elastically accommodated in the restriction portion based on the charging socket cover rotating to the open position.

The system, wherein the ball plunger may comprise a ball member provided in the charging socket cover and configured to be movable in a direction in which the ball member enters or exits the restriction portion, and a plunger spring configured to elastically support a movement of the ball member relative to the charging socket cover. The system, wherein the restriction portion may comprise a first restriction groove, and a second restriction groove provided to be spaced apart from the first restriction groove along a rotation route of the ball plunger.

The system, wherein, based on the charging robot coming into contact with the charging socket cover in a state in which the ball plunger is accommodated in the first restriction groove by a rotation of the charging socket cover made by the contact between the charging robot and the cover lever, the charging socket cover is configured to additionally rotate, and the ball plunger is configured to be accommodated in the second restriction groove.

The system, wherein the cover locker may comprise a cam member provided on the object and having a cam profile provided along a periphery of the cam member, a cam plunger provided in the charging socket cover so as to come into elastic contact with the cam profile and configured to move, based on a rotation of the charging socket cover, along the cam profile, a restriction portion provided in the object, and a ball plunger provided in the charging socket cover and configured to be elastically accommodated in the restriction portion based on the charging socket cover rotating to the open position.

The system, wherein the cam profile may comprise a first cam portion configured to be spaced apart from a rotation center of the charging socket cover at a first distance, a second cam portion continuously connected to a first end of the first cam portion and configured to be spaced apart from the rotation center of the charging socket cover at a second distance shorter than the first distance, and a third cam portion continuously connected to a second end of the first cam portion and configured to be spaced apart from the rotation center of the charging socket cover at a third distance shorter than the first distance, wherein the charging socket cover disposed at the closed position is secured based on the cam plunger being in contact with the second cam portion, and wherein the charging socket cover disposed at the open position is secured based on the cam plunger being in contact with the third cam portion.

The system, wherein the cam plunger may comprise a contact member provided in the charging socket cover and configured to be movable in a direction in which the contact member comes into contact with or moves away from the cam profile, and an elastic member configured to elastically support a movement of the contact member relative to the charging socket cover.

The system, wherein the ball plunger may comprise a ball member provided in the charging socket cover and configured to be movable in a direction in which the ball member enters or exits the restriction portion, and a plunger spring configured to elastically support a movement of the ball member relative to the charging socket cover. The system, wherein the restriction portion may comprise a first restriction groove, and a second restriction groove provided to be spaced apart from the first restriction groove along a rotation route of the ball plunger.

The system, wherein, based on the charging robot coming into contact with the charging socket cover in a state in which the ball plunger is accommodated in the first restriction groove by a rotation of the charging socket cover made by the contact between the charging robot and the cover lever, the charging socket cover is configured to additionally rotate, and the ball plunger is configured to be accommodated in the second restriction groove.

The system, wherein the cover lever is configured to be rotatable around one end relative to the charging socket cover.

The system, wherein the cover locker may comprise a push bar provided on the charging socket cover, and a push button assembly provided on the object and configured to selectively restrict, based on a push manipulation of the push bar made by the contact of the charging robot, the push bar.

The system, wherein the object may comprise an electric vehicle, and wherein the charging robot is configured to automatically open or close the charging socket cover and automate electrical charging of the electric vehicle.

### BRIEF DESCRIPTION OF THE DRAWINGS

FIG. 1 shows an example of a charging system according to an example of the present disclosure.

FIG. 2 and FIG. 3 show examples of a structure and operational structure of a cover locker of the charging system according to the example of the present disclosure.

FIG. 4, FIG. 5, FIG. 6, and FIG. 7 show examples of a process of opening or closing a charging socket cover of the charging system according to the example of the present disclosure.

FIG. 8, FIG. 9, FIG. 10, FIG. 11, and FIG. 12 show another example of the cover locker of the charging system according to the example of the present disclosure.

### DETAILED DESCRIPTION

Hereinafter, exemplary examples of the present disclosure will be described in detail with reference to the accompanying drawings.

However, the technical spirit of the present disclosure is not limited to some examples described herein but may be implemented in various different forms. One or more of the constituent elements in the examples may be selectively combined and substituted for use within the scope of the technical spirit of the present disclosure.

In addition, unless otherwise specifically and explicitly defined and stated, the terms (including technical and scientific terms) used in the examples of the present disclosure may be construed as the meaning which may be commonly understood by the person with ordinary skill in the art to which the present disclosure pertains. The meanings of the commonly used terms such as the terms defined in dictionaries may be interpreted in consideration of the contextual meanings of the related technology.

In addition, the terms used in the examples of the present disclosure are for explaining the examples, not for limiting the present disclosure.

In the present specification, unless particularly stated otherwise, a singular form may also include a plural form. The expression “at least one (or one or more) of A, B, and C” may include one or more of all combinations that can be made by combining A, B, and C.

In addition, the terms such as first, second, A, B, (a), and (b) may be used to describe constituent elements of the examples of the present disclosure.

These terms are used only for the purpose of discriminating one constituent element from another constituent element, and the nature, the sequences, or the orders of the constituent elements are not limited by the terms.

Further, when one constituent element is described as being ‘connected’, ‘coupled’, or ‘attached’ to another constituent element, one constituent element may be connected, coupled, or attached directly to another constituent element or connected, coupled, or attached to another constituent element through still another constituent element interposed therebetween.

In addition, the expression “one constituent element is provided or disposed above (on) or below (under) another constituent element” includes not only a case in which the two constituent elements are in direct contact with each other, but also a case in which one or more other constituent elements are provided or disposed between the two constituent elements. The expression “above (on) or below (under)” may mean a downward direction as well as an upward direction based on one constituent element.

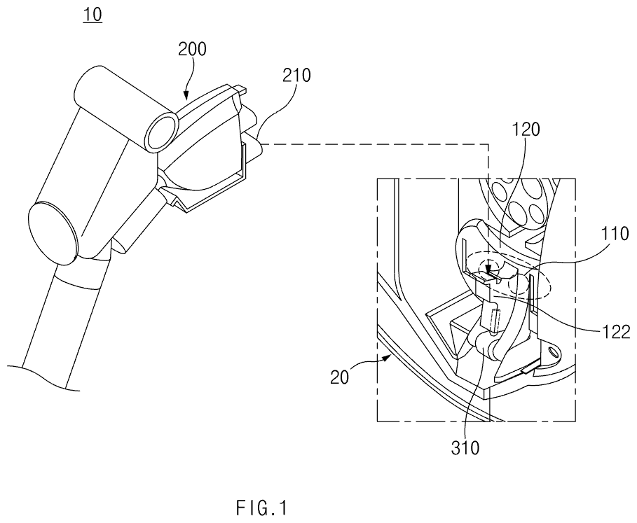

With reference to FIGS. 1 to 12, a charging system 10 according to an example of the present disclosure includes a charging socket 110 provided in an object 20, a charging robot 200 configured to move a charging connector configured to be connected to the charging socket 110, a charging socket cover 120 provided on the object 20 and configured to be movable from a first position at which the charging socket cover 120 closes the charging socket 110 to a second position at which the charging socket cover 120 opens the charging socket 110 on the basis of contact of the charging robot 200, and a cover locker (e.g., a cover locking part 300) configured to temporarily maintain the state in which the charging socket cover 120 is disposed at the first or second position.

For reference, the charging system 10 according to the example of the present disclosure may be applied to various objects 20 (e.g., an electric vehicle, electric bicycle, drone, electric boat, electric wheelchair, electric scooter, or electric skateboard, etc.) having the charging socket 110 provided to charge the object 20 with electrical energy. The present disclosure is not restricted or limited by the type and properties of the object 20 to which the charging system 10 is applied.

For example, the charging system 10 according to the example of the present disclosure may be applied to mobility vehicles such as electric vehicles (e.g., passenger vehicles or commercial vehicles), ships, or aircraft equipped with batteries. Hereinafter, an example will be described in which the charging system 10 according to the example of the present disclosure is applied to perform a process of coupling a charger 210 to the charging socket 110 of the electric vehicle and a process of opening or closing the charging socket cover 120.

The charging socket 110 is provided in the object 20 (e.g., a vehicle body of the electric vehicle) and configured to be coupled to the charger 210 for charging the electric vehicle with electrical energy.

The type and specifications of the charging socket 110 (e.g., Type 1 (SAE J1772), Type 2 (Mennekes), Combined Charging System (CCS), CHAdeMO, Tesla Supercharger, GB/T, or Type 3 (Scame), etc.) may be variously changed in accordance with required conditions and design specifications. The present disclosure is not restricted or limited by the type and specifications of the charging socket.

For example, the charging socket 110 may include at least any one of a slow charging socket, a quick charging socket, and an integrated charging socket capable of performing both quick charging and slow charging.

The charging robot 200 is configured to selectively move the charger 210 of the charging station that is to be connected (coupled) to the charging socket. The process of coupling the charger 210 of the charging station to the charging socket 110 may be automated and unmanned by the charging robot 200.

Various robots capable of transferring the charger 210 while being connected to (or gripping) the charger 210 may be used as the charging robot 200. The present disclosure is not restricted or limited by the type and structure of the charging robot 200.

For example, a multi-axis robot capable of transferring the charger 210 in an X-axis direction, a Y-axis direction, and a Z-axis direction may be used as the charging robot 200. A multi-axis robot may move or manipulate objects in multiple directions or along multiple axes of movement to perform complex, precise tasks by moving in a combination of linear (forward/backward, up/down, left/right) and rotational (pitch, yaw, roll) motions. Each axis provides an additional degree of freedom, increasing the flexibility and range of movements the robot can perform.

Further, the charger 210 may have various structures having a charging connector capable of being electrically connected (coupled) to the charging socket. The present disclosure is not restricted or limited by the type and structure of the charger 210.

The charging socket cover 120 is provided on the object 20 and configured to selectively open or close the charging socket on the basis of the contact of the charging robot 200.

For reference, in the example of the present disclosure, the charging socket cover 120 may be defined as including both a cover member configured to open or close the charging socket 110 provided in the vehicle body of the electric vehicle and a charging part door provided to cover an entire charging part of the vehicle body including the cover member (e.g., the charging part having the slow charging socket and the quick charging socket).

More specifically, the charging socket cover 120 is configured to be movable from the first position at which the charging socket cover 120 closes the charging socket 110 to the second position at which the charging socket cover 120 opens the charging socket 110 on the basis of the contact of the charging robot 200.

In this case, the configuration in which the charging socket cover 120 moves from the first position (closing position) at which the charging socket cover 120 closes the charging socket 110 to the second position (opening position) at which the charging socket cover 120 opens the charging socket 110 may be defined as including both a configuration in which the charging socket cover 120 rotates from the first position to the second position and a configuration in which the charging socket cover 120 rectilinearly or straightforwardly moves from the first position to the second position.

According to the example of the present disclosure, the charging socket cover 120 may be configured to be rotatable about a rotary shaft 124 from the first position to the second position in a hinged manner.

For example, the rotary shaft 124 of the charging socket cover 120 may be provided at a lower end of the charging socket cover 120 based on a direction approximately parallel to the vehicle body (a lower end based on an upward/downward direction of the vehicle body). Alternatively, the rotary shaft 124 of the charging socket cover 120 may be provided at an upper end of or other positions on the charging socket cover 120. Alternatively, the rotary shaft 124 of the charging socket cover 120 may be provided at a lateral end of the charging socket cover 120 based on a direction approximately perpendicular to the vehicle body (a lateral end based on a forward/rearward direction of the vehicle body).

Meanwhile, in the example of the present disclosure shown and described above, the example is described in which the charging socket cover 120 rotates about the rotary shaft 124 from the first position to the second position. However, according to another example of the present disclosure, the charging socket cover may be configured to rectilinearly or straightforwardly move (slide) from the first position to the second position in a sliding manner.

The charging socket cover 120 may have various structures with which the charging robot 200 may come into contact. The present disclosure is not restricted or limited by the structure and shape of the charging socket cover 120.

For example, the charging socket cover 120 may have an approximately elliptical shape that covers the entire charging socket 110. According to another example of the present disclosure, the charging socket cover may have a circular shape, a quadrangular shape, or other shapes (e.g., oval shape, rectangular shape, triangular shape, hexagonal shape, elliptical shape, pentagonal shape, octagonal shape, trapezoidal shape, or semi-circular or irregular (custom) shape, etc.).

According to the example of the present disclosure, the charging system 10 for the object 20 may include a cover lever 122 provided on the charging socket cover 120 and configured such that the charging robot 200 may come into contact with the cover lever 122. The charging socket cover 120 may be configured to move (rotate) from the first position to the second position on the basis of the contact of the charging robot 200 with the cover lever 122.

For example, the cover lever 122 may be provided in the form of a protrusion or lever protruding from an outer surface of the charging socket cover 120 in a direction in which the charger 210 is inserted into the charging socket 110 (a direction perpendicular to the outer surface of the charging socket cover 120).

The operation of opening or closing the charging socket cover 120 by the contact of the charging robot 200 may be implemented in various ways in accordance with required conditions and design specifications.

According to the example of the present disclosure, the charging socket cover 120 may be configured to move from the first position to the second position on the basis of only one contact between the charging robot 200 and the cover lever 122 made by the rectilinear or straightforward movement of the charging robot 200.

In this case, the configuration in which the charging socket cover 120 is moved by only one contact between the charging robot 200 and the cover lever 122 made by the rectilinear or straightforward movement of the charging robot 200 may be understood as a configuration in which the charging socket cover 120 is moved (moved from the first position to the second position) by the manipulation (one-touch manipulation) made by only one contact of the charging robot 200 with the cover lever 122 while the charging robot 200 rectilinearly or straightforwardly moves without performing an additional operation of gripping or pulling the cover lever 122.

For example, the charging robot 200 may be configured to rectilinearly or straightforwardly move in the upward/downward direction relative to the charging socket cover 120. The charging robot 200 may come into contact with the cover lever 122 only once while rectilinearly or straightforwardly moving in the upward/downward direction. According to another example of the present disclosure, the charging robot may be configured to come into contact with the cover lever to open or close the charging socket cover while rectilinearly moving in the horizontal direction or other directions relative to the charging socket cover.

The cover locking part 300 is configured to temporarily maintain or secure the state in which the charging socket cover 120 is disposed at the first or second position.

In this case, the configuration in which the state in which the charging socket cover 120 is disposed at the first or second position is temporarily maintained is defined as a configuration in which the movement (rotation) of the charging socket cover 120 is temporarily restricted in the state in which the charging socket cover 120 is disposed at the first or second position.

The cover locking part 300 may have various structures capable of temporarily maintaining or securing the state in which the charging socket cover 120 is positioned at the first or second position. The present disclosure is not restricted or limited by the structure and operating method of the cover locking part 300.

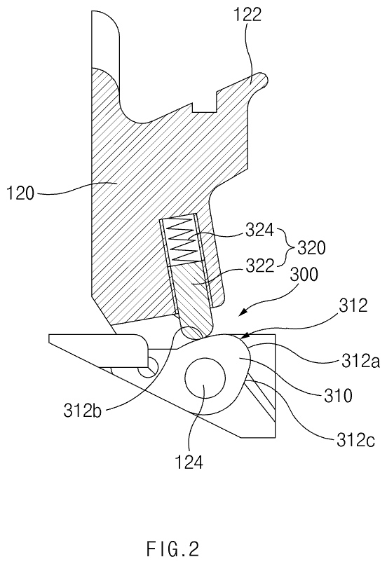

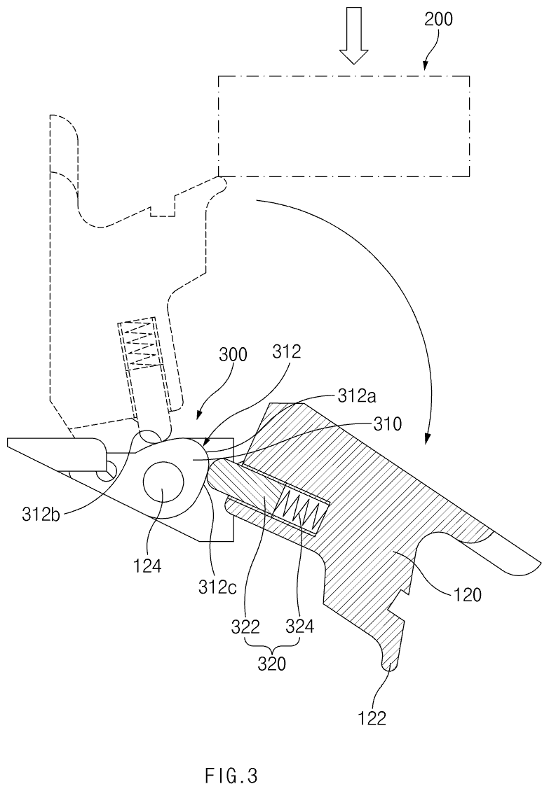

With reference to FIG. 2 and FIG. 3, according to the example of the present disclosure, the cover locking part 300 may include a cam member 310 provided on the object 20 and having a cam profile 312 provided along a periphery thereof, and a cam plunger 320 provided in the charging socket cover 120 so as to come into elastic contact with the cam profile 312 and configured to move along the cam profile 312 on the basis of the rotation of the charging socket cover 120.

The cam member 310 may have various structures having the cam profile 312 provided along the periphery of the cam member 310. The present disclosure is not restricted or limited by the structures and shapes of the cam member 310 and the cam profile 312.

For reference, the cam profile 312 is configured to temporarily restrict an arrangement state of the cam plunger 320 with respect to the cam member 310 in order to temporarily maintain or secure the state in which the charging socket cover 120 is positioned at the first or second position.

According to the example of the present disclosure, the cam profile 312 may include a first cam portion 312a having an approximate crest portion shape and defined to be spaced apart from a rotation center of the charging socket cover 120 at a first distance, a second cam portion 312b continuously connected to one end of the first cam portion 312a, having an approximate trough portion shape, and defined to be spaced apart from the rotation center of the charging socket cover 120 at a second distance shorter than the first distance, and a third cam portion 312c continuously connected to the other end of the first cam portion 312a, having an approximate trough portion shape, and defined to be spaced apart from the rotation center of the charging socket cover 120 at a third distance shorter than the first distance. If the cam plunger 320 comes into contact with the second cam portion 312b, the state in which the charging socket cover 120 is disposed at the first position (closing position) may be temporarily maintained. If the cam plunger 320 comes into contact with the third cam portion 312c, the state in which the charging socket cover 120 is disposed at the second position (opening position) may be temporarily maintained.

Hereinafter, an example will be described in which the second distance and the third distance are defined to be equal to each other. Alternatively, the second distance and the third distance may be defined to be different from each other.

For example, the first cam portion 312a, the second cam portion 312b, and the third cam portion 312c may be configured to collectively constitute the cam profile 312 with an approximate “V” shape, chevron shape, or angular shape. Alternatively, the first cam portion 312a, the second cam portion 312b, and the third cam portion 312c may be configured to collectively constitute the cam profile 312 with a “W” shape, double-vee shape, zigzag shape, or other shapes.

The cam plunger 320 may be provided in the charging socket cover 120 and may come into elastic contact with the cam profile 312. The cam plunger 320 may be configured to move along the cam profile 312 on the basis of the rotation of the charging socket cover 120 relative to the object 20.

The cam plunger 320 may have various structures capable of coming into elastic contact with the cam profile. The present disclosure is not restricted or limited by the structure of the cam plunger 320.

According to the example of the present disclosure, the cam plunger 320 may include a contact member 322 provided in the charging socket cover 120 and configured to be movable in a direction in which the contact member 322 comes into contact with or moves away from the cam profile 312, and an elastic member 324 configured to elastically support the movement of the contact member 322 relative to the charging socket cover 120.

For example, the contact member 322 may include a contact end (not shown) having an approximately arc cross-sectional shape and configured to come into contact with the cam profile 312 while sliding along the cam profile 312. The contact member 322 may be provided in the charging socket cover 120 and configured to be rectilinearly movably in the direction in which the contact member 322 moves toward or away from the cam profile 312 (in a radial direction of the rotary shaft).

Various elastic members 324 capable of elastically supporting the movement of the contact member 322 relative to the charging socket cover 120 may be used as the elastic member 324. The present disclosure is not restricted or limited by the type and structure of the elastic member 324. For example, a spring may be used as the elastic member 324.

With the above-mentioned structure, in a state in which the contact member 322 is in contact with the second cam portion 312b, the state in which the charging socket cover 120 is disposed at the first position (closing position) may be temporarily maintained by the elastic force of the elastic member 324. In contrast, if the charging socket cover 120 is rotated (clockwise based on FIG. 3) by the contact of the charging robot 200, the contact member 322 may climb over the first cam portion 312a and come into contact with the third cam portion 312c. In the state in which the contact member 322 is in contact with the third cam portion 312c, the state in which the charging socket cover 120 is disposed at the second position (opening position) may be secured or temporarily maintained by an elastic force of the elastic member 324.

For reference, if the contact member 322 climbs over an apex of the first cam portion 312a (a point most distant from the rotation center of the charging socket cover 120) while the contact member 322 climbs over the first cam portion 312a, the contact member 322 may automatically climb over the remaining section of the first cam portion 312a (a section subsequent to the apex) and be disposed on the third cam portion 312c by the elastic force of the elastic member 324 even though the contact between the charging robot 200 and the cover lever 122 is released (a pressing force applied by the charging robot 200 is released).

According to another example of the present disclosure, a spring (e.g., a torsion spring) (not shown) may be additionally provided to elastically support the rotation of the charging socket cover 120 relative to the object 20, and the contact member 322 may be configured to elastically climb over the first cam portion 312a on the basis of an elastic force of the spring and the elastic force of the elastic member 324.

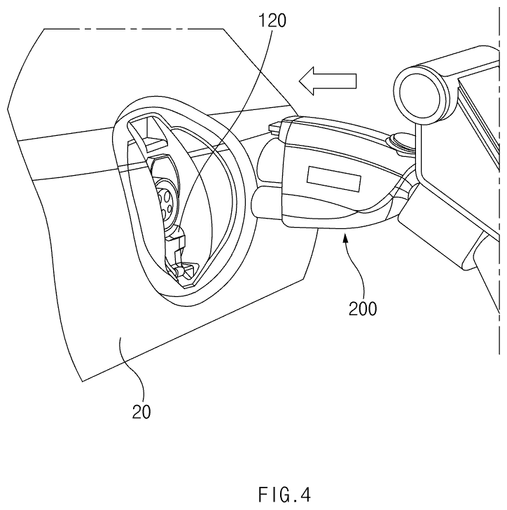

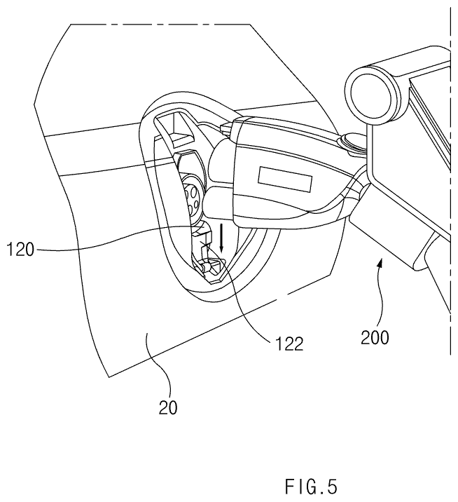

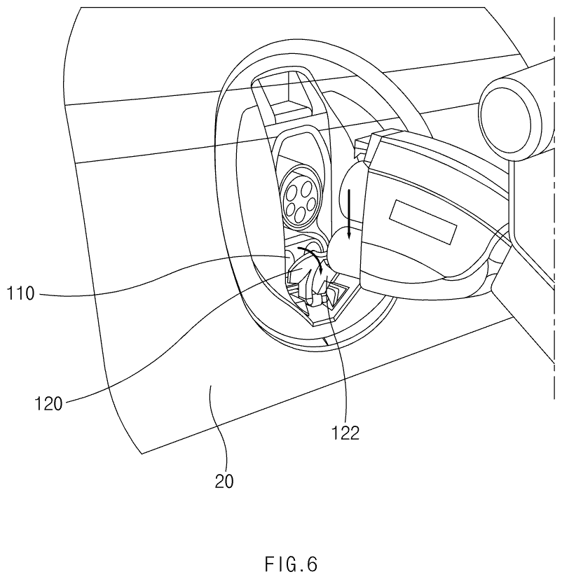

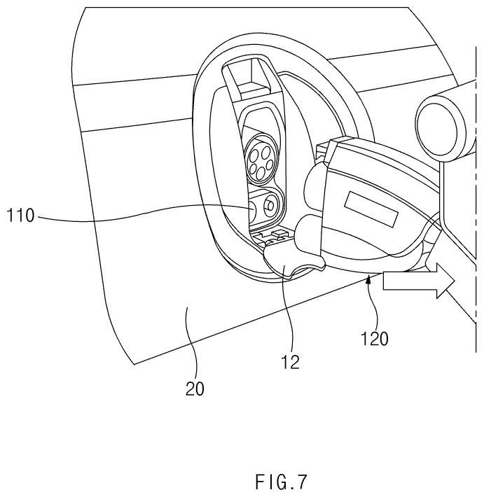

Hereinafter, FIG. 4, FIG. 5, FIG. 6 and FIG. 7 are views for explaining the process of opening or closing the charging socket cover 120.

First, as shown in FIG. 4, in order to rotate the charging socket cover 120, which is disposed at the first position (closing position), to the second position (opening position), a tip of the charging robot 200 (or a tip of the charger 210 connected to the charging robot 200) is moved to be adjacent to the charging socket cover 120 (e.g., adjacent to an upper portion of the cover lever 122).

Next, as shown in FIG. 5, if the charging robot 200 is moved downward (rectilinearly moved in a downward direction), the tip of the charging robot 200 comes into contact with the cover lever 122, as shown in FIG. 6, such that the charging socket cover 120 may move to the second position (opening position) while rotating about the rotary shaft 124, such that the charging socket 110 may be opened.

As shown in FIG. 7, the charging robot 200 may move rearward (move in the direction away from the charging socket cover 120) after the charging socket 110 is opened.

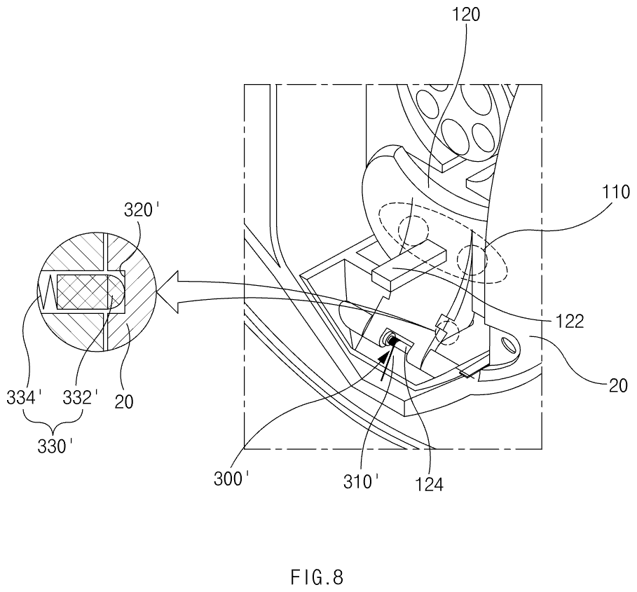

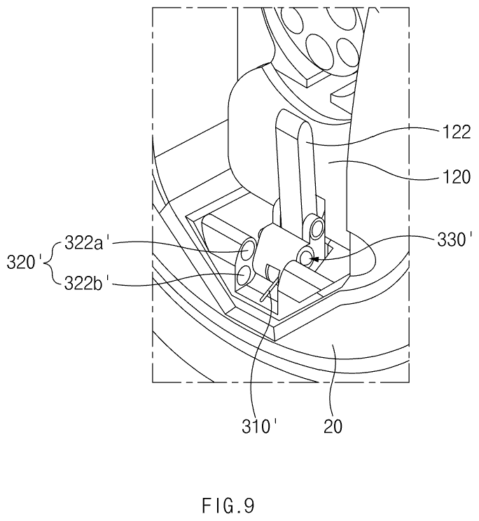

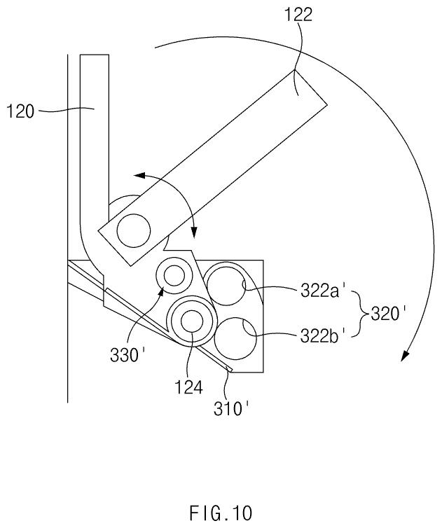

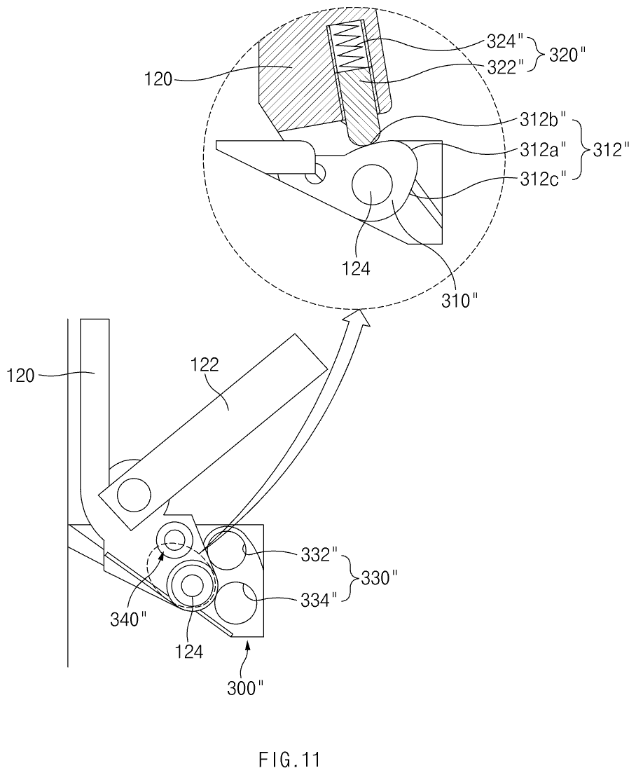

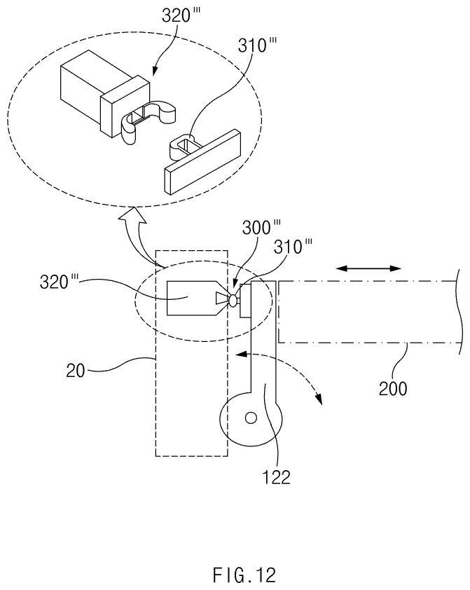

With reference to FIG. 8, according to another example of the present disclosure, the charging system 10 may include the charging socket 110 provided in the object 20, the charging robot 200 configured to move the charging connector configured to be connected to the charging socket 110, the charging socket cover 120 provided on the object 20 and configured to be movable from the first position at which the charging socket cover 120 closes the charging socket 110 to the second position at which the charging socket cover 120 opens the charging socket 110 on the basis of the contact of the charging robot 200, and a cover locking part 300′ configured to temporarily maintain the state in which the charging socket cover 120 is disposed at the first or second position. The cover locking part 300′ may include a spring member 310′ configured to provide an elastic force to rotate the charging socket cover 120 from the second position to the first position, a restriction portion 320′ provided in the object 20, and a ball plunger 330′ provided in the charging socket cover 120 and configured to be elastically accommodated in the restriction portion 320′ if the charging socket cover 120 rotates to the second position.

Various springs capable of providing an elastic force to rotate the charging socket cover 120 from the second position to the first position may be used as the spring member 310′. The present disclosure is not restricted or limited by the type and structure of the spring member 310′. For example, a torsion spring may be used as the spring member 310′. A torsion spring may be shaped like a coil configured to work by storing and releasing rotational energy through twisting in a clockwise or counterclockwise direction.

The restriction portion 320′ is provided on the object 20 and faces an approximately lateral surface of the charging socket cover 120.

The restriction portion 320′ may have various structures capable of accommodating the ball plunger 330′. The present disclosure is not restricted or limited by the structure and shape of the restriction portion 320′. For example, the restriction portion 320′ may be provided as a groove having an approximately semicircular cross-sectional shape.

The ball plunger 330′ may be provided in the charging socket cover 120 and configured to be elastically accommodated in the restriction portion 320′ if the charging socket cover 120 rotates to the second position. In the state in which the ball plunger 330′ is accommodated in the restriction portion 320′, the state in which the charging socket cover 120 is rotated to the second position may be temporarily maintained.

The ball plunger 330′ may have various structures capable of being elastically accommodated in the restriction portion 320′. The present disclosure is not restricted or limited by the structure of the ball plunger 330′.

According to the example of the present disclosure, the ball plunger 330′ may include a ball member 332′ provided in the charging socket cover 120 and configured to be movable in a direction in which the ball member 332′ enters or exits the restriction portion 320′ (a leftward/rightward direction based on FIG. 8), and a plunger spring 334′ configured to elastically support the movement of the ball member 332′ relative to the charging socket cover 120.

For example, the ball member 332′ may include a contact end (not shown) having an approximately arc cross-sectional shape and configured to come into contact with a wall surface of the object 20 (the wall surface in which the restriction portion is formed) while sliding along the wall surface. The plunger spring 334′ (e.g., a coil spring) may be interposed between the object 20 and the ball member 332′ and elastically support the movement of the ball member 332′ relative to the charging socket cover 120.

With the above-mentioned structure, the state in which the charging socket cover 120 is disposed at the first position (closing position) may be temporarily maintained by an elastic force of the spring member 310′. In contrast, if the charging socket cover 120 is rotated by a predetermined degree or more (rotated to the second position) by the contact of the charging robot 200, the ball member 332′ may be elastically accommodated in the restriction portion 320′, such that the state in which the charging socket cover 120 is disposed at the second position (opening position) may be temporarily maintained by the elastic force of the plunger spring 334′.

Meanwhile, in the example of the present disclosure shown and described above, the example has been described in which the object 20 has the single restriction portion 320′ that accommodates (restricts) the ball plunger 330′. However, according to another example of the present disclosure, a plurality of restriction portions 320′ may be formed in the object 20, and the operation of opening the charging socket cover 120 may be performed multiple times in a stepwise manner.

That is, with reference to FIG. 9 and FIG. 10, according to another example of the present disclosure, the cover locking part 300′ may include the spring member 310′ configured to provide the elastic force to rotate the charging socket cover 120 from the second position to the first position, the restriction portion 320′ provided in the object 20, and the ball plunger 330′ provided in the charging socket cover 120 and configured to be elastically accommodated in the restriction portion 320′ if the charging socket cover 120 rotates to the second position. The restriction portion 320′ may include a first restriction groove 322a′, and a second restriction groove 322b′ provided to be spaced apart from the first restriction groove 322a′ along a rotation route of the ball plunger 330′.

As in the above-mentioned example, the ball plunger 330′ may include the ball member (see 332′ in FIG. 8) provided in the charging socket cover 120 and configured to be movable in the state in which the ball member enters or exits the restriction portion 320′, and the plunger spring (see 334′ in FIG. 8) configured to elastically support the movement of the ball member 332′ relative to the charging socket cover 120. For reference, the parts identical and equivalent to the parts in the above-mentioned configuration will be designated by the identical or equivalent reference numerals, and detailed descriptions thereof will be omitted.

In particular, if the charging robot 200 comes into contact with the charging socket cover 120 again in the state in which the ball plunger 330′ is accommodated in the first restriction groove 322a′ by the rotation of the charging socket cover 120 made by the contact between the charging robot 200 and the cover lever 122, the charging socket cover 120 may additionally rotate, such that the ball plunger 330′ may be accommodated in the second restriction groove 322b′.

As described above, in the example of the present disclosure, the plurality of restriction portions 320′ (the first restriction groove and the second restriction groove) are formed in the object 20, and the operation of opening the charging socket cover 120 is performed multiple times in a stepwise manner. Therefore, it is possible to obtain an advantageous effect of further increasing an opening angle of the charging socket cover 120 and ensuring a more sufficient space in which the charging robot 200 enters the charging socket 110.

In the example of the present disclosure shown and described above, the example has been described in which the restriction portion 320′ includes the first restriction groove 322a′ and the second restriction groove 322b′. However, according to another example of the present disclosure, the restriction portion may include three or more restriction grooves.

According to the example of the present disclosure, the cover lever 122 may be configured to be rotatable about one end relative to the charging socket cover 120.

This is to minimize interference between the cover lever 122 and the charging part door in case that the charging part door (not shown) is provided to cover the charging socket cover 120.

As described above, in the example of the present disclosure, the cover lever 122 is rotatable about one end relative to the charging socket cover 120, such that the cover lever 122 may be disposed to be as closer to the outer surface of the charging socket cover 120 as possible (a degree to which the cover lever 122 protrudes to the outer surface of the charging socket cover 120 may be minimized) if the charging socket cover 120 is covered by the charging part door. Therefore, it is possible to obtain an advantageous effect of minimizing interference between the cover lever 122 and the charging part door and minimizing an error in which the charging part door is closed by the interference between the cover lever 122 and the charging part door.

With reference to FIG. 11, according to another example of the present disclosure, the charging system 10 may include the charging socket 110 provided in the object 20, the charging robot 200 configured to move the charging connector configured to be connected to the charging socket 110, the charging socket cover 120 provided on the object 20 and configured to be movable from the first position at which the charging socket cover 120 closes the charging socket 110 to the second position at which the charging socket cover 120 opens the charging socket 110 on the basis of the contact of the charging robot 200, and a cover locking part 300″ configured to temporarily maintain the state in which the charging socket cover 120 is disposed at the first or second position. The cover locking part 300′″ may include a cam member 310′″ provided on the object 20 and having a cam profile 312′″ provided along a periphery thereof, a cam plunger 320″ provided in the charging socket cover 120 so as to come into elastic contact with the cam profile 312′″ and configured to move along the cam profile 312′″ on the basis of the rotation of the charging socket cover 120, a restriction portion 320″ provided in the object 20, and a ball plunger 330′″ provided in the charging socket cover 120 and configured to be elastically accommodated in the restriction portion 320′″ if the charging socket cover 120 rotates to the second position.

For reference, the parts identical and equivalent to the parts in the above-mentioned configuration will be designated by the identical or equivalent reference numerals, and detailed descriptions thereof will be omitted.

According to the example of the present disclosure, the cam profile 312′″ may include a first cam portion 312a′″ defined to be spaced apart from the rotation center of the charging socket cover 120 at a first distance, a second cam portion 312b′″ continuously connected to one end of the first cam portion 312a′″ and defined to be spaced apart from the rotation center of the charging socket cover 120 at a second distance shorter than the first distance, and a third cam portion 312c″ continuously connected to the other end of the first cam portion 312a″ and defined to be spaced apart from the rotation center of the charging socket cover 120 at a third distance shorter than the first distance. If the cam plunger 320′″ comes into contact with the second cam portion 312b′″, the state in which the charging socket cover 120 is disposed at the first position (closing position) may be temporarily maintained. If the cam plunger 320″ comes into contact with the third cam portion 312c″, the state in which the charging socket cover 120 is disposed at the second position (opening position) may be temporarily maintained.

According to the example of the present disclosure, the cam plunger 320′″ may include a contact member 322′″ provided in the charging socket cover 120 and configured to be movable in a direction in which the contact member 322′″ comes into contact with or moves away from the cam profile 312″, and an elastic member 324″ configured to elastically support the movement of the contact member 322′″ relative to the charging socket cover 120.

According to the example of the present disclosure, the ball plunger 330′″ may include a ball member 332′ provided in the charging socket cover 120 and configured to be movable in a direction in which the ball member 332′ enters or exits the restriction portion 320″, and a plunger spring 334′ configured to elastically support the movement of the ball member 332′ relative to the charging socket cover 120.

In particular, the restriction portion 320″ may include a first restriction groove 332″, and a second restriction groove 334″ provided to be spaced apart from the first restriction groove 332′″ along a rotation route of the ball plunger 330′″. In addition, if the charging robot 200 comes into contact with the charging socket cover 120 again in the state in which the ball plunger 330′″ is accommodated in the first restriction groove 322a″ by the rotation of the charging socket cover 120 made by the contact between the charging robot 200 and the cover lever 122, the charging socket cover 120 may additionally rotate, such that the ball plunger 330′″ may be accommodated in the second restriction groove 334″.

As described above, in the example of the present disclosure, the state in which the charging socket cover 120 is disposed at the first or second position is maintained by the dual restriction structure using the cam plunger 320′″ and the ball plunger 330″. Therefore, it is possible to obtain an advantageous effect of minimizing an abnormal movement (rotation) of the charging socket cover 120 caused by an external impact, vibration, and the like and more stably maintaining the arrangement state of the charging socket cover 120.

With reference to FIG. 12, according to another example of the present disclosure, the charging system 10 may include the charging socket 110 provided in the object 20, the charging robot 200 configured to move the charging connector configured to be connected to the charging socket 110, the charging socket cover 120 provided on the object 20 and configured to be movable from the first position at which the charging socket cover 120 closes the charging socket 110 to the second position at which the charging socket cover 120 opens the charging socket 110 on the basis of the contact of the charging robot 200, and the cover locking part 300 configured to temporarily maintain the state in which the charging socket cover 120 is disposed at the first or second position. The cover locking part 300 may include a push bar 310″ provided on the charging socket cover 120, and a push button assembly 320′″ provided on the object 20 and configured to selectively restrict the push bar 310′″ on the basis of a push manipulation of the push bar 310′″ made by the contact of the charging robot 200.

The push bar 310′″ may have various structures capable of being restricted by the push button assembly 320′″. The present disclosure is not restricted or limited by the structure and shape of the push bar 310″.

For example, the push bar 310″ may include a push rod (not shown) having an approximately straight shape, and a push head portion (not shown) provided at an end of the push rod and having a larger cross-sectional area of the push rod.

The push button assembly 320′″ may have various structures capable of selectively restricting the push bar 310′″ on the basis of the push manipulation of the push bar 310′″. The present disclosure is not restricted or limited by the type and structure of the push button assembly 320″.

For example, the push button assembly 320″ may include a push button housing (not shown), and a pair of fastening finger members (not shown) configured to move toward or away from each other and configured to enter the inside of the push button housing or exit to the outside of the push button housing on the basis of the push manipulation of the push bar 310″.

With the above-mentioned structure, if the fastening finger members, together with the push bar 310″, enter the inside of the push button housing during the push manipulation of the push bar 310″, the push bar 310′″ (push head portion) may be restricted between the fastening finger members. In contrast, during the next push manipulation of the push bar 310″, the fastening finger members are spread apart from each other while being withdrawn to the outside of the push button housing, such that the restriction of the push bar 310′″ made by the fastening finger members may be released.

Meanwhile, in the example of the present disclosure shown and described above, the example has been described in which the charging socket cover 120 moves from the first position at which the charging socket cover 120 closes the charging socket 110 to the second position at which the charging socket cover 120 opens the charging socket 110 on the basis of the contact of the charging robot 200 in a semiautomatic manner. However, according to another example of the present disclosure, the charging socket cover 120 may be configured to be automatically opened or closed on the basis of driving power of a driving source (e.g., a motor) regardless of whether the charging robot 200 comes into contact with the charging socket cover 120.

A system implementing the features described herein may enable easy opening of charging cover through a mechanical mechanism that may not rely on an electronic structure, making it convenient opening by both charging robots or humans. An electric vehicle charging robot may open the charging cover, without significant modifications to the electric vehicle charging robot, completing the charging process in an unmanned manner.

The present disclosure has been made in an effort to provide a charging system capable of simplifying and automating a process of charging an electric vehicle.

In particular, the present disclosure has been made in an effort to allow a process of coupling a charger to a charging socket and a process of opening or closing a charging socket cover to be automated and unmanned by using a single charging robot without changing a structure of the charging robot or additionally providing a separate cover opening/closing robot.

Among other things, the present disclosure has been made in an effort to automatically perform the process of opening or closing the charging socket cover by allowing the charging robot to perform a one-touch manipulation on the charging socket cover without changing the structure of the charging robot.

The present disclosure has also been made in an effort to improve the user convenience and reduce the time and the number of processes required for the charging process.

The present disclosure has also been made in an effort to reduce costs and improve a spatial utilization and degree of design freedom of a charging station.

The objects to be achieved by the examples are not limited to the above-mentioned objects, but also include objects or effects that may be understood from the solutions or examples described below.

In order to achieve the above-mentioned objects, an example of the present disclosure provides a charging system for an object, the charging system including: a charging socket provided in the object; a charging robot configured to move a charging connector configured to be connected to the charging socket; a charging socket cover provided on the object and configured to be movable from a first position at which the charging socket cover closes the charging socket to a second position at which the charging socket cover opens the charging socket on the basis of contact of the charging robot; and a cover locking part configured to temporarily maintain a state in which the charging socket cover is disposed at the first or second position.

This is to simplify and automate a process of charging an electric vehicle.

That is, in the related art, even though the process of coupling the charger to the charging socket is automated by using the charging robot, a process of opening or closing the charging socket cover needs to be manually operated by the user, which causes a problem in that the process of charging the electric vehicle cannot be completely automated and unmanned.

In addition, in order to automate the process of opening or closing the charging socket cover, a cover opening/closing robot needs to be additionally provided separately from the charging robot or a structure of the charging robot needs to be changed (designed and modified) to a structure capable of opening or closing the charging socket cover (a structure capable of gripping a handle of the charging socket cover and pulling the charging socket cover), which causes a problem in that costs are increased, and a spatial utilization and a degree of design freedom are degraded.

In contrast, according to the example of the present disclosure, the charging socket cover is opened or closed on the basis of the contact of the charging robot. Therefore, it is possible to obtain an advantageous effect of allowing the process of coupling the charger to the charging socket and the process of opening or closing the charging socket cover to be automated and unmanned.

Among other things, according to the example of the present disclosure, the charging socket cover is opened or closed by the one-touch manipulation of the charging robot on the charging socket cover. Therefore, it is possible to obtain an advantageous effect of allowing the process of coupling the charger to the charging socket and the process of opening or closing the charging socket cover to be automated and unmanned by using the single charging robot without changing a structure of the charging robot or additionally providing a separate cover opening/closing robot.

In the example of the present disclosure, the configuration in which the charging socket cover moves from the first position at which the charging socket cover closes the charging socket to the second position at which the charging socket cover opens the charging socket may be defined as including both a configuration in which the charging socket cover rotates from the first position to the second position and a configuration in which the charging socket cover rectilinearly moves from the first position to the second position.

According to the example of the present disclosure, the charging socket cover may be configured to be rotatable about a rotary shaft from the first position to the second position.

The charging socket cover may have various structures with which the charging robot may come into contact.

According to the example of the present disclosure, the charging system may include: a cover lever provided on the charging socket cover so that the charging robot comes into contact with the cover lever, and the charging socket cover may move from the first position to the second position on the basis of the contact of the charging robot with the cover lever.

The operation of opening or closing the charging socket cover on the basis of the contact of the charging robot may be implemented in various ways in accordance with required conditions and design specifications.

According to the example of the present disclosure, the charging socket cover may be configured to move from the first position to the second position on the basis of only one contact between the charging robot and the cover lever made by the rectilinear movement of the charging robot.

The cover locking part may have various structures capable of temporarily maintaining the state in which the charging socket cover is disposed at the first or second position.

According to the example of the present disclosure, the cover locking part may include: a cam member provided on the object and having a cam profile provided along a periphery thereof; and a cam plunger provided in the charging socket cover so as to come into elastic contact with the cam profile and configured to move along the cam profile on the basis of a rotation of the charging socket cover.

According to the example of the present disclosure, the cam profile may include: a first cam portion defined to be spaced apart from a rotation center of the charging socket cover at a first distance; a second cam portion (or a second trough portion) continuously connected to one end of the first cam portion and defined to be spaced apart from the rotation center of the charging socket cover at a second distance shorter than the first distance; and a third cam portion continuously connected to the other end of the first cam portion and defined to be spaced apart from the rotation center of the charging socket cover at a third distance shorter than the first distance, the state in which the charging socket cover is disposed at the first position may be temporarily maintained if the cam plunger is in contact with the second cam portion, and the state in which the charging socket cover is disposed at the second position may be temporarily maintained if the cam plunger is in contact with the third cam portion.

The cam plunger may have various structures capable of coming into elastic contact with the cam profile. The present disclosure is not restricted or limited by the structure of the cam plunger.

According to the example of the present disclosure, the cam plunger may include: a contact member provided in the charging socket cover and configured to be movable in a direction in which the contact member comes into contact with or moves away from the cam profile; and an elastic member configured to elastically support a movement of the contact member relative to the charging socket cover.

According to the example of the present disclosure, the cover locking part may include: a spring member configured to provide an elastic force to allow the charging socket cover to rotate from the second position to the first position; a restriction portion provided in the object; and a ball plunger provided in the charging socket cover and configured to be elastically accommodated in the restriction portion if the charging socket cover rotates to the second position.

The ball plunger may have various structures capable of being elastically accommodated in the restriction portion.

According to the example of the present disclosure, the ball plunger may include: a ball member provided in the charging socket cover and configured to be movable in a direction in which the ball member enters or exits the restriction portion; and a plunger spring configured to elastically support a movement of the ball member relative to the charging socket cover.

According to the example of the present disclosure, the restriction portion may include: a first restriction groove; and a second restriction groove provided to be spaced apart from the first restriction groove along a rotation route of the ball plunger.

In particular, if the charging robot comes into contact with the charging socket cover in a state in which the ball plunger is accommodated in the first restriction groove by a rotation of the charging socket cover made by the contact between the charging robot and the cover lever, the charging socket cover may additionally rotate, and the ball plunger may be accommodated in the second restriction groove.

As described above, in the example of the present disclosure, the plurality of restriction portions (the first restriction groove and the second restriction groove) are formed in the object, and the operation of opening the charging socket cover is performed multiple times in a stepwise manner. Therefore, it is possible to obtain an advantageous effect of further increasing an opening angle of the charging socket cover and ensuring a more sufficient space in which the charging robot enters the charging socket.

According to the example of the present disclosure, the cover lever may be configured to be rotatable about one end relative to the charging socket cover.

As described above, in the example of the present disclosure, the cover lever is rotatable about one end relative to the charging socket cover, such that the cover lever may be disposed to be as closer to the outer surface of the charging socket cover as possible (a degree to which the cover lever protrudes to the outer surface of the charging socket cover may be minimized) if the charging socket cover is covered by the charging part door. Therefore, it is possible to obtain an advantageous effect of minimizing interference between the cover lever and the charging part door and minimizing an error in which the charging part door is closed by the interference between the cover lever and the charging part door.

According to the example of the present disclosure, the cover locking part may include: a cam member provided on the object and having a cam profile provided along a periphery thereof; a cam plunger provided in the charging socket cover so as to come into elastic contact with the cam profile and configured to move along the cam profile on the basis of a rotation of the charging socket cover; a restriction portion provided in the object; and a ball plunger provided in the charging socket cover and configured to be elastically accommodated in the restriction portion if the charging socket cover rotates to the second position.

According to the example of the present disclosure, the cam profile may include: a first cam portion defined to be spaced apart from a rotation center of the charging socket cover at a first distance; a second cam portion continuously connected to one end of the first cam portion and defined to be spaced apart from the rotation center of the charging socket cover at a second distance shorter than the first distance; and a third cam portion continuously connected to the other end of the first cam portion and defined to be spaced apart from the rotation center of the charging socket cover at a third distance shorter than the first distance, the state in which the charging socket cover is disposed at the first position (closing position) may be temporarily maintained if the cam plunger is in contact with the second cam portion, and the state in which the charging socket cover is disposed at the second position (opening position) may be temporarily maintained if the cam plunger is in contact with the third cam portion.

According to the example of the present disclosure, the cam plunger may include: a contact member provided in the charging socket cover and configured to be movable in a direction in which the contact member comes into contact with or moves away from the cam profile; and an elastic member configured to elastically support a movement of the contact member relative to the charging socket cover.

According to the example of the present disclosure, the ball plunger may include: a ball member provided in the charging socket cover and configured to be movable in a direction in which the ball member enters or exits the restriction portion; and a plunger spring configured to elastically support a movement of the ball member relative to the charging socket cover.

In particular, the restriction portion may include: a first restriction groove; and a second restriction groove provided to be spaced apart from the first restriction groove along a rotation route of the ball plunger. In addition, if the charging robot comes into contact with the charging socket cover in a state in which the ball plunger is accommodated in the first restriction groove by a rotation of the charging socket cover made by the contact between the charging robot and the cover lever, the charging socket cover may additionally rotate, and the ball plunger may be accommodated in the second restriction groove.

As described above, in the example of the present disclosure, the state in which the charging socket cover is disposed at the first or second position is maintained by the dual restriction structure using the cam plunger and the ball plunger. Therefore, it is possible to obtain an advantageous effect of minimizing an abnormal movement (rotation) of the charging socket cover caused by an external impact, vibration, and the like and more stably maintaining the arrangement state of the charging socket cover.

According to the example of the present disclosure, the cover locking part may include: a push bar provided on the charging socket cover; and a push button assembly provided on the object and configured to selectively restrict the push bar on the basis of a push manipulation of the push bar made by the contact of the charging robot.

According to the example of the present disclosure described above, it is possible to obtain an advantageous effect of simplifying and automating the process of charging the electric vehicle.

In particular, according to the example of the present disclosure, it is possible to obtain an advantageous effect of allowing the process of coupling the charger to the charging socket and the process of opening or closing the charging socket cover to be automated and unmanned by using the single charging robot without changing a structure of the charging robot or additionally providing a separate cover opening/closing robot.

Among other things, according to the example of the present disclosure, it is possible to automate the process of opening or closing the charging socket cover by allowing the charging robot to perform a one-touch manipulation on the charging socket cover without changing the structure of the charging robot.

In addition, according to the example of the present disclosure, it is possible to obtain an advantageous effect of improving the user convenience and reducing the time and the number of processes required for the charging process.

In addition, according to the example of the present disclosure, it is possible to obtain an advantageous effect of reducing the costs and improving the spatial utilization and degree of design freedom of the charging station.

While the examples have been described above, the examples are just illustrative and not intended to limit the present disclosure. It can be appreciated by those skilled in the art that various modifications and applications, which are not described above, may be made to the present example without departing from the intrinsic features of the present example. For example, the respective constituent elements specifically described in the examples may be modified and then carried out. Further, it should be interpreted that the differences related to the modifications and applications are included in the scope of the present disclosure defined by the appended claims.

What is claimed is:

1. A system for charging an object, the system comprising:
a charging socket provided in the object and configured to couple to a charger;
a charging robot configured to move the charger;
a charging socket cover provided on the object and configured to move, based on contact of the charging robot, from a closed position, where the charging socket cover closes the charging socket, to an open position, where the charging socket cover opens the charging socket; and
a cover locker configured to secure the charging socket cover disposed at the closed position or the open position.

2. The system of claim 1, comprising:
a cover lever provided on the charging socket cover so that the charging robot comes into contact with the cover lever,
wherein the charging socket cover is configured to move, based on contact between the charging robot and the cover lever, from the closed position to the open position.

3. The system of claim 2, wherein the contact between the charging robot and the cover lever is made by a rectilinear movement of the charging robot.

4. The system of claim 2, wherein the charging socket cover is configured to be rotatable around a rotary shaft from the closed position to the open position.

5. The system of claim 4, wherein the cover locker comprises:
a cam member provided on the object and having a cam profile provided along a periphery of the cam member; and
a cam plunger provided in the charging socket cover so as to come into elastic contact with the cam profile, wherein the cam plunger is configured to move, based on a rotation of the charging socket cover, along the cam profile.

6. The system of claim 5, wherein the cam profile comprises:
a first cam portion configured to be spaced apart from a rotation center of the charging socket cover at a first distance;
a second cam portion continuously connected to a first end of the first cam portion and configured to be spaced apart from the rotation center of the charging socket cover at a second distance shorter than the first distance; and
a third cam portion continuously connected to a second end of the first cam portion and configured to be spaced apart from the rotation center of the charging socket cover at a third distance shorter than the first distance,
wherein the charging socket cover disposed at the closed position is secured based on the cam plunger being in contact with the second cam portion, and
wherein the charging socket cover disposed at the open position is secured based on the cam plunger being in contact with the third cam portion.

7. The system of claim 5, wherein the cam plunger comprises:
a contact member provided in the charging socket cover and configured to be movable in a direction in which the contact member comes into contact with or moves away from the cam profile; and
an elastic member configured to elastically support a movement of the contact member relative to the charging socket cover.

8. The system of claim 4, wherein the cover locker comprises:
a spring member configured to provide an elastic force to allow the charging socket cover to rotate from the open position to the closed position;
a restriction portion provided in the object; and
a ball plunger provided in the charging socket cover and configured to be elastically accommodated in the restriction portion based on the charging socket cover rotating to the open position.

9. The system of claim 8, wherein the ball plunger comprises:
a ball member provided in the charging socket cover and configured to be movable in a direction in which the ball member enters or exits the restriction portion; and
a plunger spring configured to elastically support a movement of the ball member relative to the charging socket cover.

10. The system of claim 8, wherein the restriction portion comprises:
a first restriction groove; and
a second restriction groove provided to be spaced apart from the first restriction groove along a rotation route of the ball plunger.

11. The system of claim 10, wherein, based on the charging robot coming into contact with the charging socket cover in a state in which the ball plunger is accommodated in the first restriction groove by a rotation of the charging socket cover made by the contact between the charging robot and the cover lever, the charging socket cover is configured to additionally rotate, and the ball plunger is configured to be accommodated in the second restriction groove.

12. The system of claim 4, wherein the cover locker comprises:
a cam member provided on the object and having a cam profile provided along a periphery of the cam member;
a cam plunger provided in the charging socket cover so as to come into elastic contact with the cam profile and configured to move, based on a rotation of the charging socket cover, along the cam profile;
a restriction portion provided in the object; and
a ball plunger provided in the charging socket cover and configured to be elastically accommodated in the restriction portion based on the charging socket cover rotating to the open position.

13. The system of claim 12, wherein the cam profile comprises:
a first cam portion configured to be spaced apart from a rotation center of the charging socket cover at a first distance;
a second cam portion continuously connected to a first end of the first cam portion and configured to be spaced apart from the rotation center of the charging socket cover at a second distance shorter than the first distance; and
a third cam portion continuously connected to a second end of the first cam portion and configured to be spaced apart from the rotation center of the charging socket cover at a third distance shorter than the first distance,
wherein the charging socket cover disposed at the closed position is secured based on the cam plunger being in contact with the second cam portion, and
wherein the charging socket cover disposed at the open position is secured based on the cam plunger being in contact with the third cam portion.

14. The system of claim 12, wherein the cam plunger comprises:
a contact member provided in the charging socket cover and configured to be movable in a direction in which the contact member comes into contact with or moves away from the cam profile; and
an elastic member configured to elastically support a movement of the contact member relative to the charging socket cover.

15. The system of claim 12, wherein the ball plunger comprises:
a ball member provided in the charging socket cover and configured to be movable in a direction in which the ball member enters or exits the restriction portion; and
a plunger spring configured to elastically support a movement of the ball member relative to the charging socket cover.

16. The system of claim 12, wherein the restriction portion comprises:
a first restriction groove; and
a second restriction groove provided to be spaced apart from the first restriction groove along a rotation route of the ball plunger.

17. The system of claim 16, wherein based on the charging robot combing into contact with the charging socket cover in a state in which the ball plunger is accommodated in the first restriction groove by a rotation of the charging socket cover made by the contact between the charging robot and the cover lever, the charging socket cover is configured to additionally rotate, and the ball plunger is configured to be accommodated in the second restriction groove.

18. The system of claim 2, wherein the cover lever is configured to be rotatable around one end relative to the charging socket cover.

19. The system of claim 1, wherein the cover locker comprises:
a push bar provided on the charging socket cover; and
a push button assembly provided on the object and configured to selectively restrict, based on a push manipulation of the push bar made by the contact of the charging robot, the push bar.

20. The system of claim 1, wherein the object comprises an electric vehicle, and wherein the charging robot is configured to automatically open or close the charging socket cover and automate electrical charging of the electric vehicle.
